(19) United States
(12) Patent Application Publication
(10) Pub. No.: US 2008/0141223 A1
(43) Pub. Date: Jun. 12, 2008

(54) Mock source program generation program, method and apparatus

(75) Inventor: Akira Naruse, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/903,961

(22) Filed: Sep. 25, 2007

(30) Foreign Application Priority Data
Dec. 12, 2006 (JP) 2006-334031

(51) Int. Cl. G06F 9/44

(52) U.S. Cl. 717/127

(57) ABSTRACT

This information processing method is to provide a technique enabling to easily and accurately estimate the performance improvement effect for each correction method for the parallel processing program. This information processing method includes: identifying an execution time other than a communication time for each process by using communication history data stored in a communication history data storage storing the communication history data among a plurality of processes in a parallel processing program, generating a CPU time consuming function to consume a CPU time by the identified execution time, and storing the generated CPU time consuming function into a mock source program storage; and generating a communication function to carry out a communication processing indicated by the communication history data by using the communication history data stored in the communication history data storage, and storing the generated communication function into the mock source program storage.

### TECHNICAL FIELD OF THE INVENTION

This invention relates to a technique to analyze behavior of a parallel processing program, and to improve the performance of the parallel processing program.

### BACKGROUND OF THE INVENTION

In the parallel processing program, the processing proceeds while plural processes exchanges data each other. Therefore, in order to analyze the behavior of the parallel processing program and to improve the performance of the parallel processing program, it is necessary to understand how the communication is carried out between the processes.

As a technique to grasp the run-time behavior of the parallel processing program, there is a method for gathering the communication history during execution of the parallel processing program and graphically displaying the history, conventionally. By using such a technique, it is possible to identify what problem occurs in what point of the parallel processing program, and to utilize such data for the improvement of the parallel processing program.

However, even if the problem can be grasped, it is not easy to correct the program, at first. Furthermore, the correction of the parallel processing program is more difficult than the correction of the sequential processing program. In addition, it is usual that the correction method of the problem is not limited to one, and there are various approaches. However, it is not practical to attempt all of the correction methods, when taking into consideration that the correction of the parallel processing program is difficult. Even if all of the correction methods were attempted, only one correction method is adopted, finally. Therefore, because the time consumed for the correction methods, which are not adopted, is wasteful, the work efficiency is low.

Moreover, for instance, JP-A-H6-59939 discloses a technique to accumulate various information, as trace information, in execution of an application, and carry out simulation based on the trace information. Specifically, in a parallel computer having plural processors and basically carrying out message communication each other, a message transmission start time, a message transmission end time, a destination of the transmitted message, a size, a message receipt start time, a message receipt end time, a transmission source of the received message, a size, a barrier synchronization start time, a barrier synchronization end time and the like are accumulated as trace information, in the execution of a user program. Then, the trace information is rewritten based on execution parameters of a simulator. After that, a communication time, a computation time other than the communication time or the like is calculated to evaluate the performance of the parallel computer. However, this publication does not consider generation of a mock source program of the parallel processing.

Furthermore, JP-A-2001-154998 discloses a technique to carry out parallelized analysis by providing a parallelization general linkage analysis apparatus for providing a parallelization instruction procedure, causing an analysis worker to indicate points to be parallelized, automatically generating a parallelization linkage analysis program by a parallelization linkage analysis program generation procedure, and executing the parallelization linkage analysis program. However, the generation of the mock source program, which presumes the correction by human hands, is not taken into consideration.

Furthermore, JP-A-H4-225439 discloses an analysis technique to analyze and output logs/sampling data in the parallel operation of plural processes, and which reduces the volume of logs or sampling data necessary for debug/tuning without changing the original execution behavior of a parallel computing program, and also reduces the utilization volume of an output device and a time required for the analysis after the execution. Specifically, in the parallel computing while simultaneously synchronizing the plural processes, local logs are respectively gathered at predesignated events of respective processes, or local sampling data is respectively gathered at predesignated sampling time intervals. Then, at the simultaneous synchronization, these gathered local logs or local sampling data is analyzed to output necessary logs or sampling data. However, the mock source program, which presumes the correction by the human hands, is not taken into consideration.

The aforementioned conventional arts do not disclose a technique to accurately estimating a performance improvement effect for each of the plural correction methods, and cannot efficiently carry out the correction of the parallel processing program.

### SUMMARY OF THE INVENTION

Therefore, an object of this invention is to provide a technique enabling to easily and accurately estimate the performance improvement effect for each correction method for the parallel processing program.

Furthermore, another object of this invention is to provide a technique enabling to efficiently carry out the correction of the parallel processing program.

An information processing method according to this invention includes: identifying an execution time other than a communication time for each process by using communication history data stored in a communication history data storage storing the communication history data among a plurality of processes in a parallel processing program, generating a CPU time consuming function to consume a CPU time by the identified execution time, and storing the generated CPU time consuming function into a mock source program storage; and generating a communication function to carry out a communication processing indicated by the communication history data by using the communication history data stored in the communication history data storage, and storing the generated communication function into the mock source program storage.

Thus, by using the mock source program composed of functions stored in the mock source program storage, it is possible to represent an operation of the parallel processing program, simulatively. Therefore, it is possible to attempt various correction methods by using the mock source program, which is easy to correct, and accurately estimate the performance improvement effect for respective correction methods.

The aforementioned identifying, generating and storing may include: identifying an execution time other than a communication time from a difference between a start time of a specific entry included in the communication history data and an end time of an immediately preceding entry of the specific entry.

Furthermore, the aforementioned generating the communication function may include: identifying a communication parameter of a specific entry included in the communication history data; and generating a communication function including the identified communication parameter, and storing the generated communication function into the mock source program storage.

Furthermore, the information processing method according to this invention may further include: accepting correction for the mock source program stored in the mock source program storage, and storing the mock source program after the correction as a corrected mock source program into the mock source program storage; compiling the corrected mock source program to generate a corrected mock program; and measuring an execution time by executing the corrected mock program. By carrying out such a processing, it is possible to identify a correction method that the execution time is short, and correct the actual parallel processing program based on the identified correction method. Therefore, it becomes possible to efficiently correct the parallel processing program.

Incidentally, it is possible to create a program for causing a computer to execute this information processing method according to the present invention. The program is stored into a storage medium or a storage device such as, for example, a flexible disk, a CD-ROM, a magneto-optical disk, a semiconductor memory, or a hard disk. In addition, the program may be distributed as digital signals over a network in some cases. Data under processing is temporarily stored in the storage device such as a computer memory.

### BRIEF DESCRIPTION OF THE DRAWINGS

FIG. 1 is a functional block diagram of an embodiment of this invention;

FIG. 2 is a diagram showing an example of data stored in an execution log storage;

FIG. 3 is a diagram showing a processing flow of a mock code generator;

FIG. 4 is a diagram showing an example of a mock source program;

FIGS. 5A and 5B are diagrams showing an example of the mock source programs;

FIG. 6 is a diagram showing a situation when the mock source program shown in FIGS. 5A and 5B is compiled and executed;

FIGS. 7A and 7B are diagrams showing a first correction example of the mock source program;

FIG. 8 is a diagram showing a situation when the mock source program shown in FIGS. 7A and 7B is compiled and executed;

FIGS. 9A and 9B are diagrams showing a second correction example of the mock source program;

FIG. 10 is a diagram showing a situation when the mock source program shown in FIGS. 9A and 9B is compiled and executed; and

FIG. 11 is a functional block diagram of a computer.

### DETAILED DESCRIPTION OF THE PREFERRED EMBODIMENTS

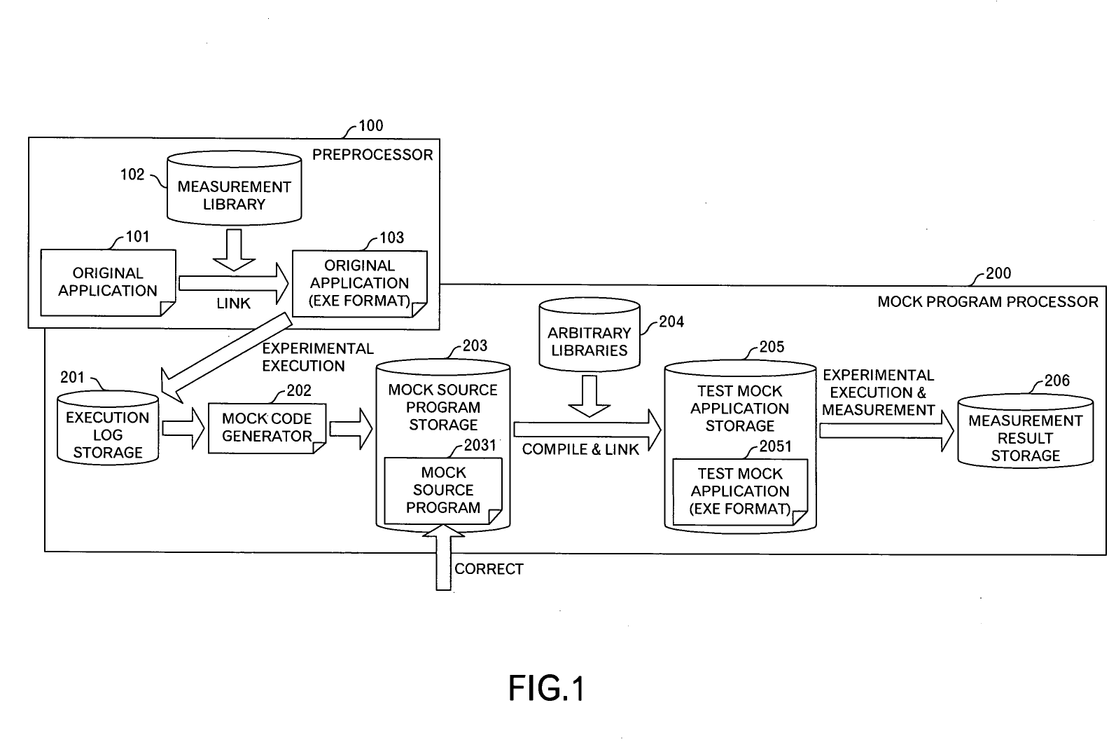

FIG. 1 shows a system outline diagram according to one embodiment of this invention. The system of this embodiment has a preprocessor 100 and a mock program processor 200. The preprocessor 100 links an original application 101 that is a parallel processing program with a measurement library 102 to generate execution logs described below, and generates an original application 103 of the parallel processing program, which can generate the execution logs. The original application 103 is an executable program (i.e. in an EXE format).

The mock program processor 200 has an execution log storage 201 that stores execution logs (specifically, communication history data) generated by experimentally executing the original application 103 (also called communication history data storage); a mock code generator 202 that generates a mock source program 2031 from the execution logs stored in the execution log storage 201; a mock source program storage 203 that stores the mock source program 2031 generated by the mock code generator 202; an test mock application storage 205 that stores an test mock application 2051 (in an EXE format) generated by compiling and linking by using the mock source program 2031 and arbitrary libraries 204 necessary to convert the mock source program 2031 into an EXE-format program; and a measurement result storage 206 that stores measurement results measured by experimentally executing the test mock application 2051. Incidentally, although it is not clearly indicated in the drawing, the mock program processor 200 may include a compiler for the parallel processing program. Similarly, because the mock source program is corrected by the user, the mock program processor 200 may include tools, editors and/or like to support the correction by the user.

The mock program processor 200 obtains the execution logs of the original application 103 experimentally executed by a parallel computer, and stores the obtained execution logs into the execution log storage 201. The mock code generator 202 of the mock program processor 200 generates the mock source program 2031 by using the execution logs stored in the execution log storage 201, and stores the generated mock source program 2031 into the mock source program storage 203. Although the details are explained later, the mock source program 2031 is a program to realize an operation similar to the operation of the original application 103 in a simplified form, and is used in order to evaluate the performance improvement effects of the correction methods by correcting the mock source program 2031, by using feasible correction methods, on behalf of the original application 103. Therefore, the mock source program 2031 stored in the mock source program storage 203 is corrected by the user. The mock source program 2031 after the correction is linked with the arbitrary libraries 204 and compiled. The test mock application 2051 generated as a compilation result is stored in the test mock application storage 205. After that, the test mock application 2051 is executed by the parallel computer, and the execution time is simultaneously measured and stored into the measurement result storage 206. By the execution time stored in this measurement result storage 206, it is possible to judge whether or not the correction method carried out by the user is effective. That is, when the execution time becomes extremely short, it is judged that the correction method is effective, and when the execution time does not become short, it is judged that such a method is not effective. When the correction method is not effective, the processing returns to the correction of the mock source program 2031, again.

When it is confirmed that the correction method is effective, the user actually carries out the correction to the source codes of the parallel processing program according to the attempted effective correction method. Incidentally, although it is possible to easily correct the mock source program 2031, the correction of the source codes of the parallel processing program is much difficult. Therefore, there is a case where the attempted effective correction method is not realized. In such a case, another effective correction method is searched.

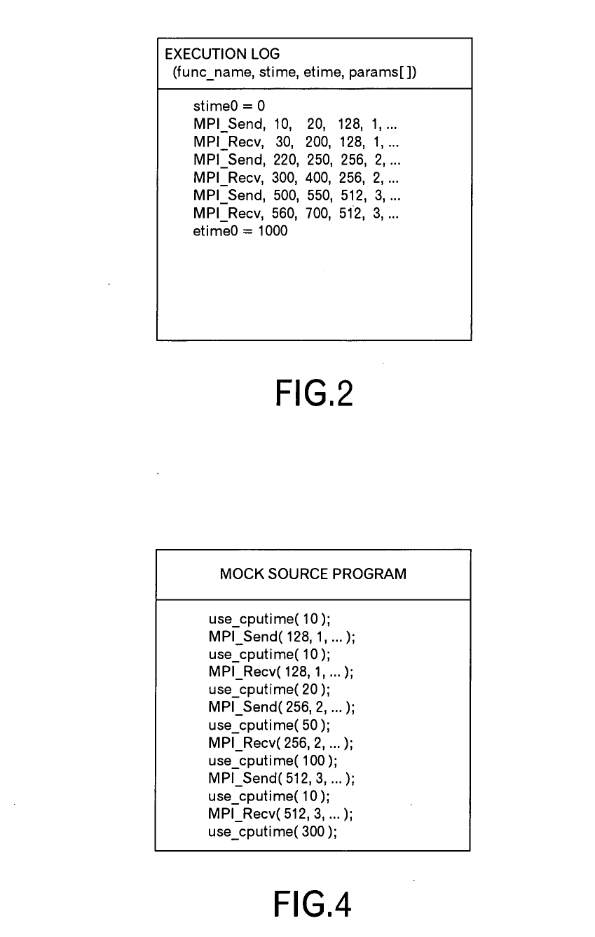

Next, FIG. 2 shows an example of data stored in the execution log storage 201. The example of FIG. 2 shows the execution logs for one process. In the example of FIG. 2, an extraction start time is recorded in the first line, and an extraction end time is recorded in the last line (the eighth line). A communication function name (func_name), a start time (stime), an end time (etime) and various parameters (params[ ]. e.g. communicated data volume and destination process ID) are registered in the second to seventh lines. In this embodiment, either MPI_Send function to transmit data or MPI_Recv function to receive data is registered.

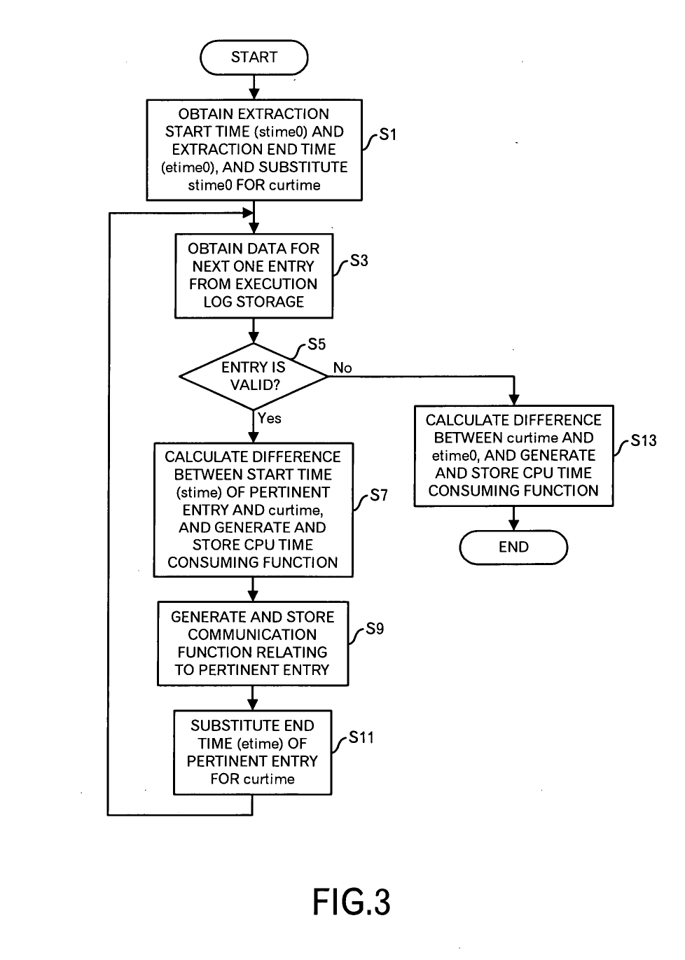

By using such execution logs, the mock code generator 202 generates the mock source program 2031 by executing a processing shown in FIG. 3. First, the mock code generator 202 obtains the extraction start time (stime0) and the extraction end time (etime0), which are stored in the execution log storage 201, and substitutes stime0 for a variable curtime (step S1). Next, the mock code generator 202 obtains data for next one entry from the execution log storage 201 (step S3). Then, the mock code generator 202 judges whether or not the obtained entry is valid (step S5). More specifically, it judges whether or not the obtained entry indicates a communication function. When the obtained entry is valid, the mock code generator 202 calculates a difference between the start time (stime) of the pertinent entry and the variable curtime, generates a CPU time consuming function, which consumes the CPU time by the difference time, and stores the CPU time consuming function into the mock source program storage 203 (step S7). Then, the mock code generator 202 extracts the parameters of the communication function from the pertinent entry, generates a communication function including the extracted parameters and relating to the pertinent entry, and stores the generated communication function into the mock source program storage 203 (step S9).

In addition, the mock code generator 202 substitutes the end time (etime) of the pertinent entry for the variable curtime (step S11). Then, the processing returns to the step S3.

On the other hand, when the entry is judged to be invalid, the mock code generator 202 calculates a difference between the variable curtime and the extraction end time etime0, generates a CPU time consuming function, which consumes the CPU time by the difference time, and stores the CPU time consuming function into the mock source program storage 203 (step S13). Then, the processing is completed.

By carrying out such a processing, the mock source program 2031 as shown in FIG. 4 is generated from the execution logs as shown in FIG. 2, for example. First, a CPU time consuming function use_cputime(10), which consumes the CPU time by the difference “10” between the start time stime=10 in the second line of the execution logs and the extraction start time stime0=0, is generated, and stored into the mock source program storage 203. Next, parameters (128, 1, . . . ) in the second line of the execution logs are identified, and a communication function MPI_Send (128, 1, . . . ) is generated from the parameters and the communication function MPI_Send in the second line of the execution logs, and stored into the mock source program storage 203. Here, the end time etime=20 in the second line of the execution logs is substituted for curtime.

Furthermore, a CPU time consuming function use_cputime(10), which consumes the CPU time by a difference “10” between the start time stime=30 in the third line of the execution logs and curtime=20, is generated and stored into the mock source program storage 203. Next, parameters (128, 1, . . . ) in the third line of the execution logs are identified, and a communication function MPI_Recv (128, 1, . . . ) is generated from the parameters and a communication function MPI_Recv in the third line of the execution logs, and stored into the mock source program storage 203. Here, the end time etime=200 in the third line of the execution logs is substituted for curtime.

Furthermore, a CPU time consuming function use_cputime(20), which consumes the CPU time by a difference “20” between the start time stime=220 in the fourth line of the execution logs and curtime=200, is generated and stored into the mock source program storage 203. Next, parameters (256, 2, . . . ) in the fourth line of the execution logs are identified, and a communication function MPI_Send (256, 2, . . . ) is generated from the parameters and the communication function MPI_Send in the fourth line of the execution logs and stored into the mock source program storage 203. Here, the end time etime=250 in the fourth line of the execution logs is substituted for curtime.

When carrying out the similar processing in the following, the mock source program 2031 as shown in FIG. 4 is generated. The user corrects the mock source program 2031 by a tool or editor in the mock program processor 200, for example.

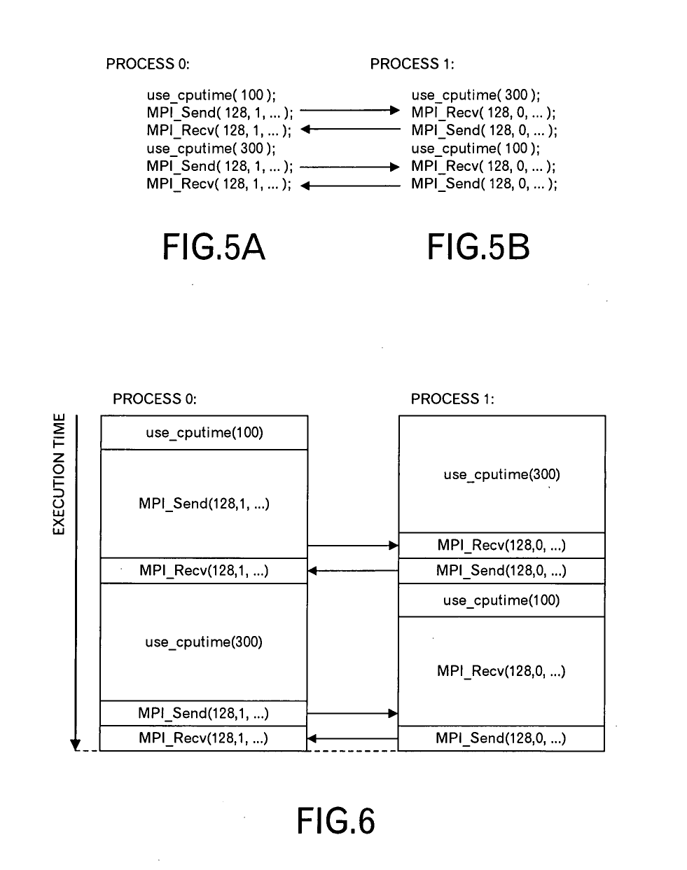

Next, a correction example of the mock source program 2031 and a verification example of the performance improvement effect will be explained by using FIGS. 5A to 10. First, it is assumed that a mock source program for a process 0 as shown in FIG. 5A is obtained, and a mock source program for a process 1 as shown in FIG. 5B is obtained. Here, it is also assumed that the processing proceeds while exchanging data between these two processes. That is, the process 0 uses MPI_Send (128, 1, . . . ), the process 1 uses MPI_Recv (128, 0, . . . ), and data is transmitted from the process 0 to the process 1. In addition, the process 1 uses MPI_Send (128, 0, . . . ), the process 0 uses MPI_Recv (128, 1, . . . ), and data is transmitted from the process 1 to the process 1. Such a processing is further carried out once more.

The detail execution time measurement result, which is obtained by linking and compiling the mock source programs as shown in FIGS. 5A and 5B with the arbitrary libraries 204 to generate the test mock application 2051 and executing the test mock application 2051, is shown in FIG. 6. In the process 0, a time “100” is consumed by the CPU time consuming function use_cputime (100), and next, data is transmitted to the process 1 by MPI_Send (128, 1, . . . ). On the other hand, in the process 1, a time “300” is consumed by the CPU time consuming function use_cputime (300), and next, data is received from the process 0 by MPI_Recv (128, 0, . . . ). Here, because an offset in the time consumed by the CPU time consuming function exists, a waiting for data transmission occurs.

Incidentally, in data transmission from the process 1 to the process 0 by MPI_Send (128, 0, . . . ) in the process 1 and MPI_Recv (128, 1, . . . ) in the process 0, any transmission waiting does not occur.

Furthermore, in the process 0, a time “300” is consumed by the CPU time consuming function use_cputime (300), and next, data is transmitted to the process 1 by MPI_Send (128, 1, . . . ). On the other hand, in the process 1, a time “100” is consumed by the CPU time consuming function use_cputime (100), and next, data is received from the process 0 by MPI_Recv (128, 0, . . . ). Here, because an offset in the time consumed by the CPU time consuming function exists, a waiting for data transmission occurs.

Incidentally, in data transmission from the process 1 to the process 0 by MPI_Send (128, 0, . . . ) in the process 1 and MPI_Recv (128, 1, . . . ) in the process 0, any transmission or receipt waiting does not occur.

Thus, because load imbalance occurs, the execution time becomes long and the parallel efficiency is not good.

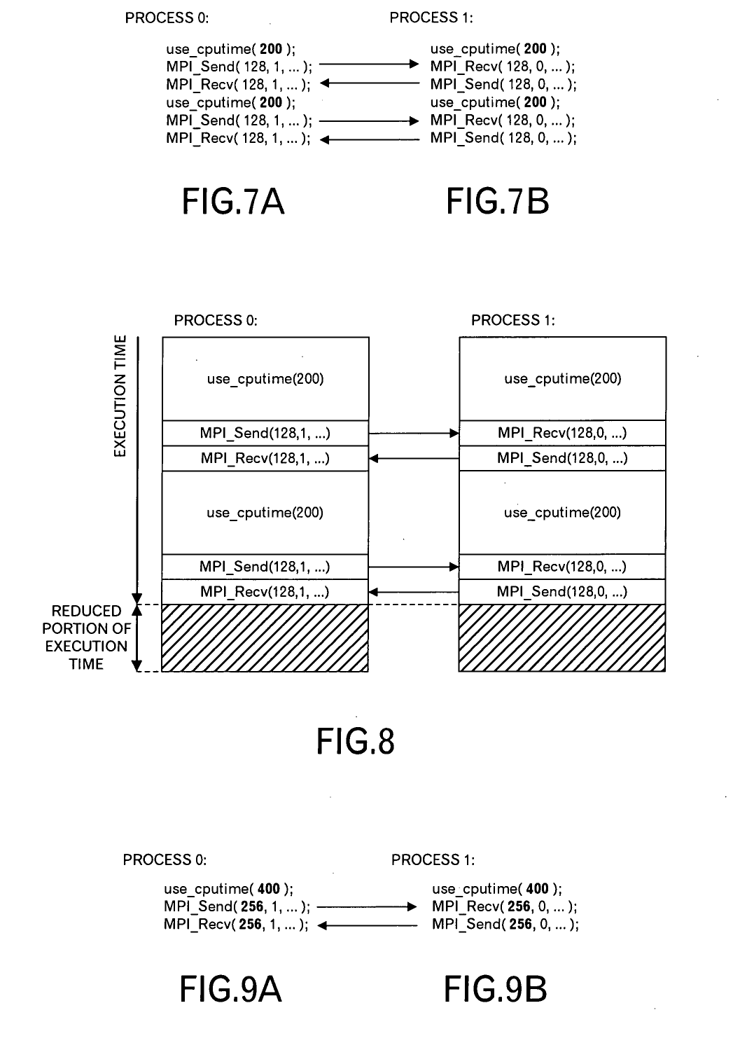

In order to resolve such load imbalance, the mock source programs as shown in FIGS. 5A and 5B are corrected as shown in FIGS. 7A and 7B. Namely, because, as shown in FIGS. 5A and 5B, in the mock source programs before the correction, during the consumption of the time “100” in the process 0, the time “300” is consumed in the process 1, and during the consumption of the time “300” in the process 0, the time “100” is consumed in the process 1, the mock source programs are corrected so that the processes 0 and 1 also consumes a time “200” without changing the number of times of the communication and the communication timings. That is, use_cputime(100) and use_cputime(300) are replaced with use_cputime(200).

When the test mock application 2051 is generated by linking and compiling the mock source program after the correction with the arbitrary libraries 204, and is experimentally executed, it is understood that the data transmission waiting and the receipt waiting at the two positions shown in FIG. 6 are resolved, as shown in FIG. 8 and the execution time is reduced by the waiting. That is, when the actual parallel processing program can be corrected so that the execution times are balanced between the processes 0 and 1, the performance improvement effect as shown in FIG. 8 can be obtained.

Next, an example of correcting the mock source programs 2031 as shown in FIGS. 5A and 5B by another method is shown in FIGS. 9A and 9B. As shown in FIG. 9A, in the process 0, use_cputime(100) and use_cputime(300) are unified to use_cputime(400), and two MPI_Send(128, 1, . . . ) are changed to one MPI_Send(256, 1, . . . ), and two MPI_Recv(128, 1, . . . ) are changed to one MPI_Recv(256, 1, . . . ). Generally, because it takes time for the activation of the communication function, the execution time must be reduced by reducing the number of communication times even when the total communication data volume is the same. FIG. 9B shows the same correction.

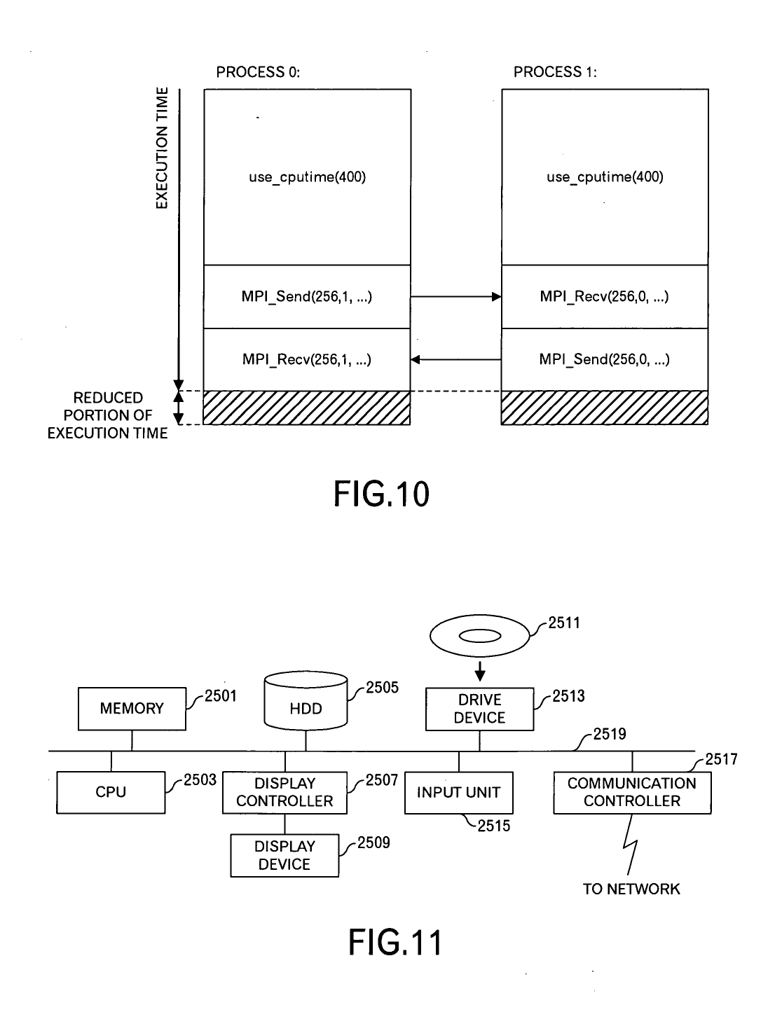

When the test mock application 2051 is generated by linking and compiling the mock source program after such correction with the arbitrary libraries 204, and is experimentally executed, the measurement result as shown in FIG. 10 is obtained, for example. However, in FIG. 10, it takes additional time for the data communication between the processes 0 and 1, and the reduced execution time is shortened. That is, it is understood that the performance improvement effect cannot obtained too much even when the correction as shown in FIGS. 9A and 9B is carried out, and it is not effective to actually carry out such correction for the parallel processing program.

As described above, by generating the mock source program 2031, it becomes possible to easily attempt various correction methods. Then, when the correction method whose performance improvement effect is high among the attempted correction methods is actually applied to the parallel processing program, it becomes possible to reduce the useless work for the parallel processing program, for which the correction is difficult, and improve the work efficiency.

Although the embodiment of this invention is described above, this invention is not limited to this embodiment. For example, the functional block diagram shown in FIG. 1 is a mere example, and there is a case where various auxiliary functions are added and the mock program processor is unified with the compiler.

In addition, as for the correction method, two examples are described above. However, another method may be adopted. In any case, by adopting the correction method whose performance improvement effect is high, the parallel processing program is corrected. However, although the mock source program 2031 can be easily corrected, the correction of the parallel processing program is difficult. Therefore, the correction method whose performance improvement effect is high cannot be actually adopted. In such a case, because the correction method whose performance improvement effect is extremely low is not applied to the parallel processing program, the improvement of the work efficiency is remarkable.

Incidentally, the preprocessor 100 and the mock program processor 200 are one or plural computer devices as shown in FIG. 11. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 11. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in detail are realized.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A mock source program generation program embodied on a computer-readable medium, said mock source program generation program comprising:
identifying an execution time other than a communication time for each process by using communication history data stored in a communication history data storage storing said communication history data among a plurality of processes in a parallel processing program, generating a CPU time consuming function to consume a CPU time by the identified execution time, and storing the generated CPU time consuming function into a mock source program storage; and
generating a communication function to carry out a communication processing indicated by said communication history data by using said communication history data stored in said communication history data storage, and storing the generated communication function into said mock source program storage.

2. The mock source program generation program as set forth in claim 1, wherein said identifying, generating and storing comprises:
identifying an execution time other than a communication time from a difference between a start time of a specific entry included in said communication history data and an end time of an immediately preceding entry of said specific entry.

3. The mock source program generation program as set forth in claim 1, wherein said generating and storing comprises:
identifying a communication parameter of a specific entry included in said communication history data; and
generating a communication function including the identified communication parameter, and storing the generated communication function into said mock source program storage.

4. A mock source program generation method, comprising:
identifying an execution time other than a communication time for each process by using communication history data stored in a communication history data storage storing said communication history data among a plurality of processes in a parallel processing program, generating a CPU time consuming function to consume a CPU time by the identified execution time, and storing the generated CPU time consuming function into a mock source program storage; and
generating a communication function to carry out a communication processing indicated by said communication history data by using said communication history data stored in said communication history data storage, and storing the generated communication function into said mock source program storage.

5. The mock source program generation method as set forth in claim 4, wherein said identifying, generating and storing comprises:
identifying an execution time other than a communication time from a difference between a start time of a specific entry included in said communication history data and an end time of an immediately preceding entry of said specific entry.

6. The mock source program generation method as set forth in claim 4, wherein said generating and storing comprises:
identifying a communication parameter of a specific entry included in said communication history data; and
generating a communication function including the identified communication parameter, and storing the generated communication function into said mock source program storage.

7. The mock source program generation method as set forth in claim 4, further comprising:
accepting correction for said mock source program stored in said mock source program storage, and storing said mock source program after said correction as a corrected mock source program into said mock source program storage;
compiling the corrected mock source program to generate a corrected mock program; and
measuring an execution time by executing the corrected mock program.

8. A mock source program generation apparatus, comprising:
a first unit that identifies an execution time other than a communication time for each process by using communication history data stored in a communication history data storage storing said communication history data among a plurality of processes in a parallel processing program, generates a CPU time consuming function to consume a CPU time by the identified execution time, and stores the generated CPU time consuming function into a mock source program storage; and
a second unit that generates a communication function to carry out a communication processing indicated by said communication history data by using said communication history data stored in said communication history data storage, and stores the generated communication function into said mock source program storage.

9. The mock source program generation apparatus as set forth in claim 8, wherein said first unit comprises:
a unit that identifies an execution time other than a communication time from a difference between a start time of a specific entry included in said communication history data and an end time of an immediately preceding entry of said specific entry.

10. The mock source program generation apparatus as set forth in claim 8, wherein said second unit comprises:
a unit that identifies a communication parameter of a specific entry included in said communication history data; and
a unit that generates a communication function including the identified communication parameter, and stores the generated communication function into said mock source program storage.
